(19) United States
(12) Patent Application Publication
(10) Pub. No.: US 2018/0296040 A1
(43) Pub. Date: Oct. 18, 2018

(54) UNITARY INSERT FOR HOLDING UTENSIL TO POT RIM

(71) Applicant: SNV CREATIONS INC., QUEBEC CITY (CA)

(72) Inventor: Steven AUDET, Quebec City (CA)

(73) Assignee: SNV CREATIONS INC., QUEBEC CITY (CA)

(21) Appl. No.: 15/861,488

(22) Filed: Jan. 3, 2018

Related U.S. Application Data
(62) Division of application No. 29/600,654, filed on Apr. 13, 2017.

(51) Int. Cl. A47J 43/28

(52) U.S. Cl. CPC A47J 43/287; F16B 2001/0035; A47G 2200/106

(57) ABSTRACT

A unitary insert for holding a utensil to the rim of a pot, includes a main portion having an integral clip on a first side able to be secured to the rim of a cooking pot and a concave receiving portion on a second side of the main portion for receiving a utensil to hold the utensil to the rim of the pot. A magnetic element may be inserted in the main portion adjacent the concave receiving portion to hold the utensil to the rim of the pot.

### CROSS REFERENCE TO RELATED APPLICATION

This application is a division of application Ser. No. 29/600,654 filed Apr. 13, 2017.

### FIELD OF THE INVENTION

The present invention relates to a unitary insert that may typically be used with a fondue pot to hold a utensil in place within the fondue pot.

### BACKGROUND OF THE INVENTION

Fondue pots are typically used in social occasions involving several people who each have their own individual fork or other utensil for use in placing food items within the fondue pot, and later retrieving the food items. Typically, each person is provided with a long handled fork which must be placed in the fondue pot for a period of time, and often such forks can slide along the rim of the pot or otherwise be relocated to often make it difficult for the person to retrieve the fork he or she intends use. Devices to hold such a fondue fork in position have been proposed, but such devices are often complex and difficult to use or assemble.

For example, U.S. Pat. No. 5,749,286 describes holding elements 16 which may include magnetic elements 22 to hold a fondue fork in position; but such holding elements need to be secured in place by use of a specifically designed cover as shown in FIG. 3 of the patent, or separate mounting structures as shown for example in FIGS. 5 and 28 that provide a structures that can be cumbersome or complicated to use or assemble. German Gebrauchsmusterschrift DE 20 2005 009 149 also discloses a holder for fondue forks that is formed of several structures including a spring clip that must be assembled.

German Offenlegungsschrift DE 42 00 407 describes a unitary device molded device, but the device holds several fondue forks at once in different orientations. European application EP 1 430 822 again requires a specific cover structure to provide grooves 21 to hold the fondue forks.

It is therefore an object of the present invention to provide a unitary insert that can be held to the rim of a pot to secure a utensil in place in a very simple manner, and, in this way, provide a device that can be used with minimal effort to secure a fondue fork to the rim of a fondue pot when the fork is inserted into the pot.

### SUMMARY OF THE INVENTION

The present invention is illustrated by way of example in the attached drawings and provides a unitary insert for holding a utensil to the rim of a pot, including a main portion having an integral clip on a first side able to be secured to the rim of a cooking pot and a concave receiving portion on a second side of the main portion for receiving a utensil to hold the utensil to the rim of the pot. Preferably, a magnetic element is inserted in the main portion adjacent the concave receiving portion to hold the utensil to the rim of the pot.

### BRIEF DESCRIPTION OF THE DRAWINGS

The attached figures illustrate a separable food utensil according to the present invention.

FIG. 1 illustrates a perspective view of an embodiment of the insert of the present invention in one manner of use with the rim of a fondue pot;

FIG. 2 illustrates in plan view the embodiment of the insert of FIG. 1;

### DETAILED DESCRIPTION OF AN EMBODIMENT

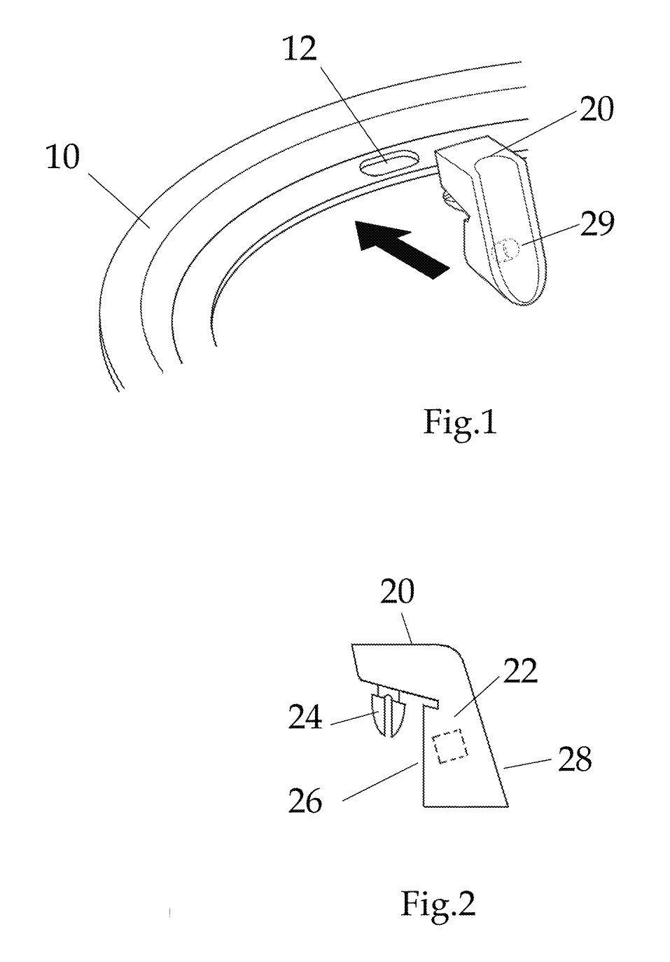

As shown in FIG. 1, the insert 20 of the present invention is intended to be used primarily with the rim 10 of a fondue pot. In preferred form, the insert of the present invention is to be fitted within an opening 12 of the rim of the fondue pot; and the insert 20 includes a main portion 22 having an integral clip 24 on a first side 26 of the main portion 22. As illustrated, the clip 24 is able to be secured within an opening 12 in the rim of a fondue or other cooking pot; but the unitary clip can be shaped in many different forms, including a molded alligator clip to serve the same purpose.

Provided on a second side 28 of the main portion 22 is a concave receiving portion 29 for receiving a utensil such as the handle of a fondue fork to hold the utensil to the rim 10 of the pot. Adjacent the concave receiving portion 29 is an opening 30 for receiving a magnetic element 32. The concave receiving portion may be sized to have the handle of a particular fork pressed fitted there within to hold the fork in place; or the magnetic element may be provided to hold the handle of the fondue fork without the need to have it sized to fit tightly within the concave receiving portion 29. As would be understood, the entire insert 20 can be unitarily molded from a synthetic plastics material such as nylon.

What is claimed is:

1. A unitary insert for holding a utensil to the rim of a pot, including a main portion having an integral clip on a first side able to be secured to the rim of a cooking pot and a concave receiving portion on a second side of the main portion for receiving a utensil to hold the utensil to the rim of the pot.

2. An insert for holding a utensil to the rim of a pot as set forth in claim 1, including a magnetic element inserted in said main portion adjacent said concave receiving portion to hold the utensil to the rim of the pot.
